(19) United States
(12) Patent Application Publication
(10) Pub. No.: US 2016/0080492 A1
(43) Pub. Date: Mar. 17, 2016

(54) SYSTEM, COMPUTER PRODUCT, AND METHOD FOR IMPLEMENTING A CLOUD SERVICE WITH PRIVATE STORAGE

(71) Applicant: 01 COMMUNIQUE LABORATORY INC., Mississauga (CA)

(72) Inventor: Andrew Cheung, Toronto (CA)

(21) Appl. No.: 14/486,492

(22) Filed: Sep. 15, 2014

(51) Int. Cl. H04L 29/08

(52) U.S. Cl. CPC H04L 67/1097

(57) ABSTRACT

The present application advantageously provides a system and method for implementing a cloud service with private storage. The system includes a storage device, a cloud server, and a client device. The system is configured in a way that the private storage device designated/owned by a user of the cloud service to initiate a communication with the cloud server to register as the user data storage location for a particular account of the cloud service rather than using a “central public storage” location as in a traditional public cloud service.

### FIELD OF THE INVENTION

The present application relates generally to a system, computer product, and method for implementing a cloud service. More particularly, the present application relates to a cloud service with private storage whereby the storage location of the cloud service can be selected by users of the cloud service to be a private storage location rather than a “central public storage” location as in a traditional public cloud service.

### BACKGROUND OF THE INVENTION

Public cloud services allow users to store their data such as general emails, contacts, calendar, notes, document files, presentation, thesis papers, pictures, videos, etc. on the cloud instead of the local hard drive of a computing device. One advantage of this mechanism is that it allows the user to seamlessly share and synchronize data among different computing devices owned by the user or even different computing devices owned by other users.

iCloud by Apple, Instagram by Facebook, Dropbox by Dropbox Inc., etc. are examples of pubic cloud service providers that allow users to seamlessly share and synchronize data among different computing devices. However, there are general concerns about privacy when using these public cloud services because “storage in the cloud” really means “storage in the servers of the public cloud service providers.” In other words, the storage of data is in a “third party's hands” regardless of the sophistication of the security measures implemented by the public cloud service provider. Emails, contacts, calendars, notes, document files, presentations, thesis papers, pictures, videos, etc. can be extremely confidential and therefore it can be very harmful if these are accessible by the public without consent from the owner of the data.

One alternative is to build a private cloud and host the servers privately. Many large organizations implement their own private cloud in this fashion. However, this solution is limited to very large organizations as the efforts involved in building and maintaining a private cloud is beyond the economic and technical capability of many small/medium organizations.

As such, it is desirable to provide a system, computer product, and method with the ease-of-use and functionality of a standard public cloud service which provide users the option of storing the data on a local storage provided by the user. The most apparent advantage of such “Private Cloud Storage” is privacy because the data never resides in the hands of any “third party”. Another advantage relates to “cyber foot print.” When the user removes the local storage, or configures a new local storage, the old storage is immediately “vanished” from the Internet forever without a trace. Such a solution can also be implemented in a cost effective manner because hard drive storage has become extremely inexpensive.

### SUMMARY OF THE INVENTION

The foregoing needs are met, to a great extent, by the system, computer product, and method discussed herein, wherein in one aspect a system is provided that in some embodiments allows a user to select and designate a local computer as the storage location of the cloud service (e.g. a computer owned by the user of the cloud service).

In accordance with one aspect, a system includes a storage device, a cloud server, and a client device. The storage device may comprise of a network station, personal computer terminal, etc. provided that such device is capable of mass storage and communication with a network (e.g. Internet). The client device is linked to a network (e.g. Internet) with user data intended for cloud services such as, but are not limited to, storing data on the cloud or sharing/synchronizing data among one of more of other client devices that the user of the cloud service designates to share/synchronize the user data. Examples of data include, but not limited to emails, contacts, calendar, notes, document files, presentation, thesis papers, pictures, videos, etc. The cloud server computer is linked to a network (e.g. Internet) and associated with a network address that can be reached publicly from the network (e.g. a static public IP address). For the sake of clarity, a practical implementation of the cloud server computer cluster may involve a load balancing mechanism that is well known at the time of this application. The storage device is configured to send a signal that includes data for locating the storage device. The cloud server computer is configured to receive from the storage device a signal that includes data for locating the storage device. A communication channel between the storage device and the cloud server computer is optionally maintained thereafter.

The client device is linked to the network (e.g. Internet) and capable of sending user data to the cloud server requesting cloud services in a manner that is well known at the time of this application. When the cloud server needs to temporarily or permanently store the user data or retrieve user data when performing the cloud services requested by a client device, the cloud server will send requests to the storage device designated by the user to fulfill the task. Since the communication channel with the storage device is initiated by the storage device and maintained by the cloud server, it works under all circumstances whether the storage device is having static/dynamic network address or whether it is publicly accessible from the network (e.g. Internet) or not such as when the storage device behind a firewall or indirectly connected to the network via a network gateway, network proxy, router, network address translator, etc. Naturally the storage device is required to be securely authenticated before it is registered by the cloud server as the designated storage for a particular user account.

As a result, no temporary or permanent storage involving the cloud service is ever stored in the storage of the cloud server on the network (e.g. Internet) so privacy has been significantly enhanced. From the same token, “Cyber foot print” can also be guaranteed when the user stops using this cloud service or configures a new local storage as the old storage will immediately be “vanished” from the Internet without a trace when it is erased, formatted, or physically removed by the user. In addition, because the storage device is manageable by the cloud server, cloud server can optionally apply limitations at the storage device such as limiting the storage space, file type, file size, etc. Finally this solution can also be implemented in a cost effective manner because hard drive storage is provided by the user of the cloud service instead of the cloud service provider.

Methods for providing the cloud services such as storing/retrieving user data on the cloud or sharing/synchronizing among more than one client device, etc. are well known at the time of this application.

In accordance with another aspect, the storage device may be directly accessible by the client devices. In this case, the cloud server may instead instruct the client devices to send requests to the storage device designated by the user to fulfill the task.

In accordance with another aspect, the storage device can be proprietary hardware capable of mass storage with computing capability designated for the purpose of a storage device in the context of this application. Typically, the proprietary hardware is a special-purpose personal computer with mass storage capability but no general keyboard/monitor as in a general purpose personal computer. It is also not equipped with general purpose applications other than software to perform the functions of a storage device in the context of this application.

There has thus been outlined, rather broadly, certain embodiments in order that the detailed description thereof herein may be better understood, and in order that the present contribution to the art may be better appreciated. There are, of course, additional embodiments that will be described below and which will form the subject matter of the claims appended hereto.

In this respect, before explaining at least one embodiment in detail, it is to be understood that the system, computer product, and method is not limited in their application to the details of construction and to the arrangements of the components set forth in the following description or illustrated in the drawings. The system, computer product, and method are capable of embodiments in addition to those described and of being practiced and carried out in various ways. Also, it is to be understood that the phraseology and terminology employed herein, as well as the abstract, are for the purpose of description and should not be regarded as limitation.

As such, those skilled in the art will appreciate that the conception upon which this disclosure is based may readily be utilized as a basis for the designing of other structures, methods and systems for carrying out the several purposes described herein. It is important, therefore, that the claims be regarded as including such equivalent constructions insofar as they do not depart from the spirit and scope of the present application.

### BRIEF DESCRIPTION OF THE DRAWINGS

FIG. 1 is a block diagram of a system according to a first preferred embodiment.

FIG. 2 is a block diagram of a system according to another preferred embodiment.

FIG. 3 is a block diagram of a system according to another preferred embodiment.

FIG. 4 is a detailed view of the storage device hardware of a preferred embodiment.

FIG. 5 is a sequence chart of a typical event relationship according to a preferred embodiment

FIG. 6 is a sequence chart of a typical event relationship according to another preferred embodiment.

### DETAILED DESCRIPTION

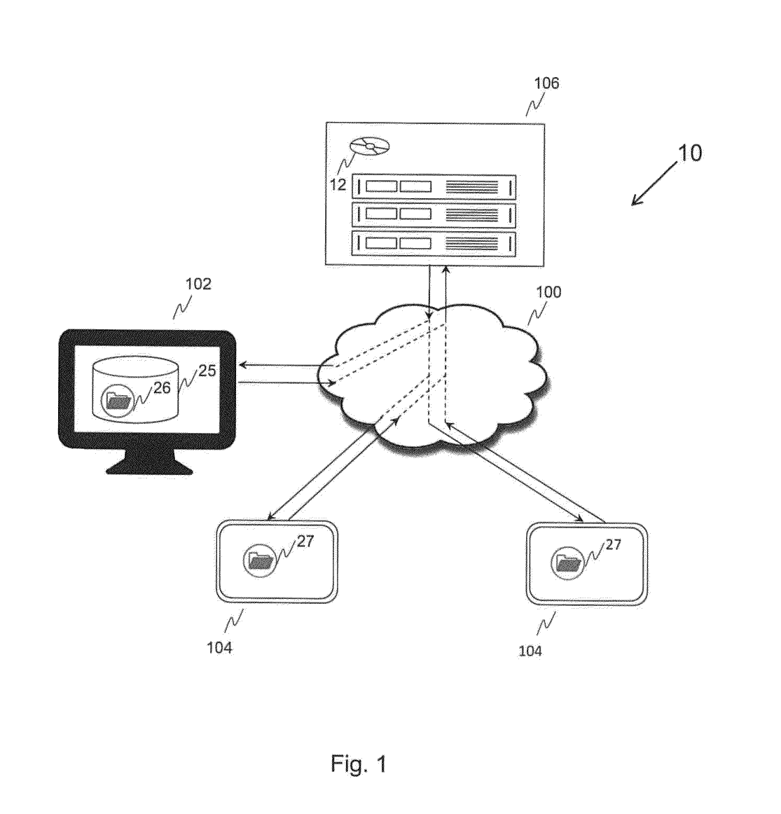

The system, computer product, and method will now be described with reference to the drawing figures, in which like reference numerals refer to like parts throughout. An embodiment in accordance with one aspect is depicted in FIG. 1 wherein a system for implementation of a cloud service with private storage is disclosed.

Generally, system 10 is an architecture that, through a combination of hardware and software, allows a user of a cloud service to specify a “private storage” designated/possessed by the specific user instead of using the “central public storage” offered by the cloud service provider as part of the cloud server. In other words, system 10 allows users to specify a local storage such as, but not limited to, a computer or a special purpose storage device as the place of storage owned by the user or other party designated by the user with mass storage spaces. System 10 allows the storage device 102 to have a static/dynamic network address and whether it is publicly accessible from the network (e.g. Internet) or not. For the sake or clarity, publicly un-accessibility can be a situation when the storage device is behind a firewall or indirectly connected to the network via a network proxy, network router, network gateway, etc. In one aspect system 10 includes security features that only an authorized storage device can be registered by the user as the private storage for the cloud functionalities. As depicted in FIG. 1, system 10 includes storage device 102, cloud server 106, and client devices 104. As depicted, the storage device 102 can be embodied as a general purpose computing device with mass storage 25. Mass storage 25 can be an internal hard drive, an external hard drive, flash drive, etc. Storage device 102 is capable of sending communication to cloud server 106 for the following purposes. First, this is desirable to provide authentication credentials to successfully register itself as the private storage of a particular cloud service user. Second, this is to provide information about its location to cloud server 106 so that cloud server 106 can communicate with storage device 102 when it needs to save/retrieve any of the user data 26 when processing a cloud service tasks such as cloud data storage/backup, data synchronization, etc. It is optional to repeat this communication from time-to-time to verify that the network connection (e.g. Internet) and server connection is active, to update the then current location of storage device 102 on the network (e.g. Internet) to cloud server 106 if the location of storage device 102 on the network is dynamic, or to automatically reconnect to cloud server 106 after a network interruption, etc.

Storage device 102 is also capable of receiving a storage/retrieval request from cloud server 106 as well as the capability to process the storage/retrieval request and store/retrieve the user data 26 following instruction in the storage/retrieval request. Examples of user data 26 include, but not limited to, emails, contacts, calendar, notes, document files, presentation, thesis papers, pictures, videos, etc. This allows users of the cloud service to avoid having copies or images of their confidential original data 27 residing in the hands of a third party (the cloud service provider)'s public storage.

Client devices 104 are computing devices such as personal computers, smartphones, tablets, etc. and are linked to original data 27 that are involved in the requests for cloud services such as cloud data storage/backup, synchronization with other client devices 104, etc. Examples of original data 27 linked to client devices 104 include, but are not limited to, emails, contacts, calendars, notes, document files, presentations, thesis papers, pictures, videos, etc. There can be one or more than one client devices 104 associated with one user account of the cloud service. Client devices 104 are capable of sending authentication credential as well as requests for cloud services to cloud server 106.

Cloud server 106 is capable of receiving a communication initiated from storage device 102 and enables a communication session with the cloud server 106. Cloud server 106 is also capable of receiving an authentication communication initiated from client device 104 and determines whether client device 104 is authorized to be a user of the cloud system 10. In addition, cloud server 106 is capable of receiving cloud service requests from client devices 104 as well as processing the cloud service requests. As well-known at the time of this application, if data synchronization to other client devices 104 is required, cloud server 106 will send data synchronization requests to client devices 104 other than the client device 104 that has initiated a cloud service request. When storage of user data 26 is needed, cloud server 106 will communicate with storage device 102 and send a storage/retrieval request to storage device 102 with an instruction to process the storage (e.g. what to store, how to store, etc.) or to retrieve user data 26 (e.g. what to retrieve, how to retrieve, etc.). For the sake of clarity, cloud server 106 has its own data storage for everything (e.g. operating system, cloud operation software, database related file, etc.) other than user data 26.

It is understood at the time of this application that a practical implementation of the cloud server computer cluster may involve a load balancing mechanism that is well known at the time of this application.

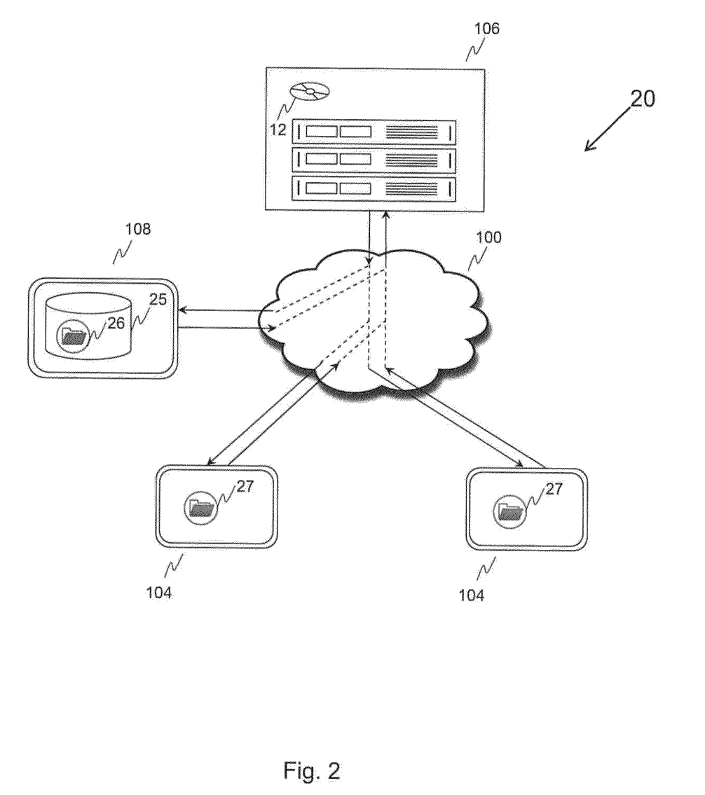

FIG. 2 is a detailed view of another preferred embodiment (20). In this embodiment, the special purpose storage device 108 is a special purpose computing device rather than a general purpose personal computer. Typically, a special purpose storage device 108 is a hardware computing device with mass storage such as hard drive, solid state driver, or USB drive, etc. as well as a small display and an input keypad as opposed to a full monitor/keyboard of a standard storage device 102. The special purpose storage device 108 is also capable of connecting to a network (e.g. Internet) with built-in network connectivity. Other than the form factor and/or physical appearance, its fundamental functionality is identical to that of storage device 102.

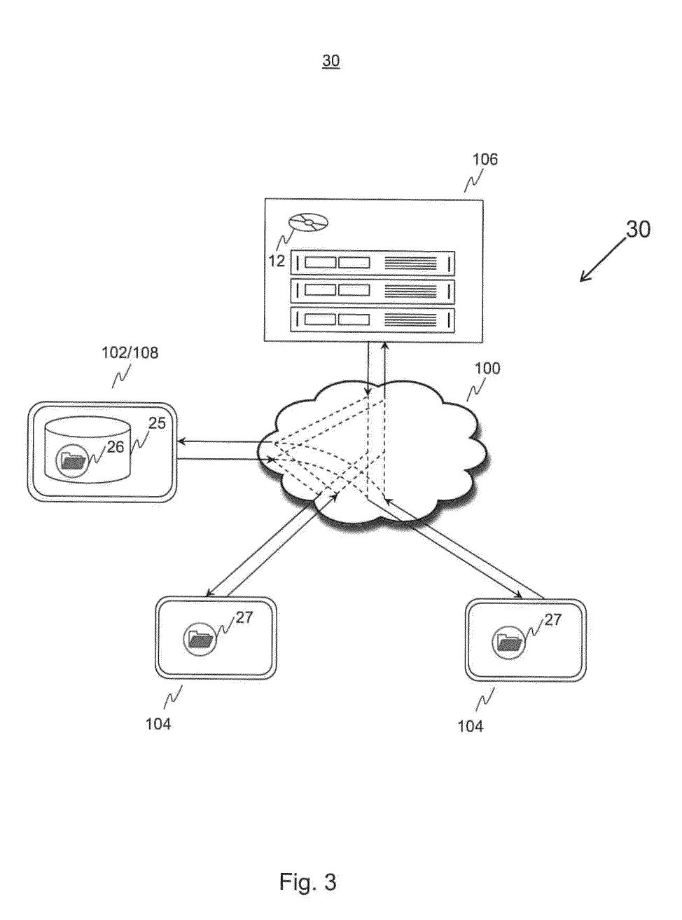

FIG. 3 is a detailed view of another preferred embodiment (30) whereby if direct connection between storage device 102/108 and client devices 104 can be established, cloud server 106 will instruct client devices 104 to directly communicate with storage device 102/108 to send storage/retrieval request(s) from client devices 104 to storage device 102/108. This allows storage/retrieval requests to be directly sent and processed between client devices 104 and storage device 102/108 instead of indirectly going through cloud server 106. This mechanism allows significant saving of bandwidth usage on cloud server 106 side required related to saving/retrieving/synchronizing of user data 26.

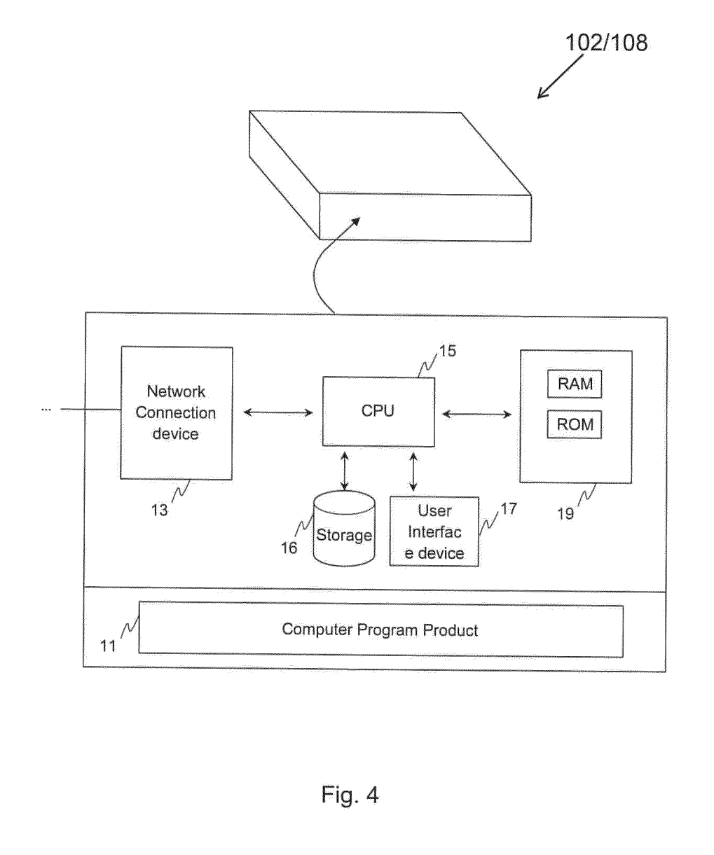

FIG. 4 is a detailed view of storage device 102/108 according to a preferred embodiment depicted in FIG. 1. Storage device 102/108 includes a mass storage 16, network connection device 13, a microprocessor 15, a user interface device 17, and a memory 19. Typically this is implemented as a special-purposes box 108 with a small display, a small keypad, and software 11 dedicated for purposes described in this application. It can also be implemented as a general purpose computer 102 with software product 11 dedicated for purposes described in this application. In any case, a user of the system 10 provides a storage device 102/108 to be used as the user's private storage of the cloud service. The storage device 102/108 will initiate a communication on the network (e.g. Internet) to the cloud server 106. The communication session can be optionally maintained between storage device 102/108 and cloud server 106. When storage or retrieval of user data 26 is needed, cloud server 106 will typically communicate with storage device 102/108 and send a storage/retrieval request with instruction to process the storage or retrieval (e.g. what to store/retrieve, how to store/retrieve, etc.) Storage device 102/108 will use mass storage 16 to fulfill any storage/retrieval requests. Mass storage 16 can be any high capacity non-volatile storage such as, but are not limited to, internal/external hard drive, hard drive array, solid state driver, or USB drive, etc.

Network connection device 13 initiates communication(s) on the network (e.g. Internet) from storage device 102/108 to cloud server 106. For example, it can be a wireless modem for connecting to a wireless network or a network interface to a network, etc. It will be appreciated by a person of ordinary skill in the art however that network connection device 13 may be of another type or more than one type in order to send a communication from storage device 102/108 to cloud server 106 to the aforementioned wired and wireless networks (e.g. Internet). For example, network connection device 13 may be a network interface capable of connecting to a network switch, router, a WiFi connection point, or 3G/4G cellular network, etc.

Memory 19 includes random access memory (RAM) and read only memory (ROM). In this embodiment, ROM is a flash EEPROM, or flash memory. The ROM or mass storage 16 can be pre-installed with an operating system and software 11 that provides the operations of storage device 102/108 such as, but are not limited to, sending out authentication requests to cloud server 106, receiving storage/retrieval requests, acknowledgement of receiving storage/retrieval request, process storage/retrieval requests, etc.

User interface device 17 provides a hardware interface between a user of cloud service and microprocessor (CPU) 15, and includes input and output devices as may be necessary for commanding storage device 102/108 (e.g. entering authentication credentials) and reporting of operation results (e.g. successful authentication). Examples of input devices include, but are not limited to, a small keypad with numeric buttons, an “ok”, and a “cancel” button, etc. It may also be a full keyboard in the situation if storage device is a general purpose computer 102. Examples of output devices include, but are not limited to, a small LCD display. It may also be a full monitor in the situation if storage device is a general purpose computer 102.

Other embodiments of storage device 102/108 have been contemplated. Although in the embodiment as shown in FIG. 4, memory 19 of storage device 102/108 for data security considerations contains only volatile storage, a person of ordinary skill in the art will understand that the application is not so limited. For example, a user may decide to store data with non-volatile memory instead.

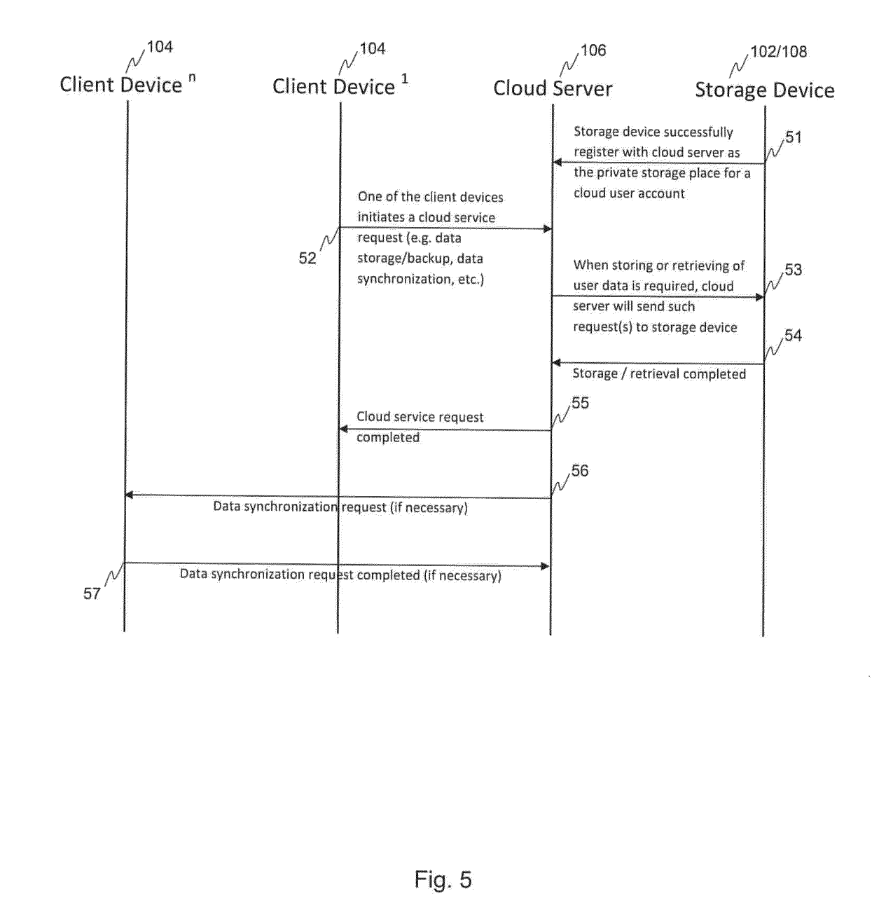

FIG. 5 is a sequence chart depicting a typical event relationship among client devices 104, cloud server 106, and storage device 102/108 according to the preferred embodiment of in FIG. 1. At the beginning storage device 102/108 must be successfully authenticated as the private storage for a particular user account of the cloud service (51). Methods for providing authentication information are well-known at the time of this application. Thereafter storage device 102/108 will be used by cloud server 106 when storage/retrieval of user data 26 is required for a certain user account of the cloud service. At any moment when one of the client devices 104 requires a cloud service (e.g. data storage/backup, new data becoming available, etc.) the initiated client device 104 (Client Device¹) will send cloud service request(s) to cloud server 106 (52). When processing a cloud service, storage/retrieval request(s) will be sent to storage device 102/108 from cloud server 106 (53) if storage/retrieval of user data 26 is required. If necessary, storage device 102/108 will then send storage/retrieval confirmation(s) back to cloud server 106 when the storage/retrieval requests have been completed (54) and followed by cloud service completion confirmation(s) back to the initiated client device 104 (Client Device¹) from cloud server 106 (55). If data synchronization is required, synchronization request(s) will be sent from cloud server 106 (56) to all other client devices 104 (Client Devices″) designated by the user to share/synchronize user data 26 received from the initiated device 104 (Client Device¹). This process is finished with confirmation(s) back to cloud server 106 from Client Devices″ when data synchronization has been completed (57).

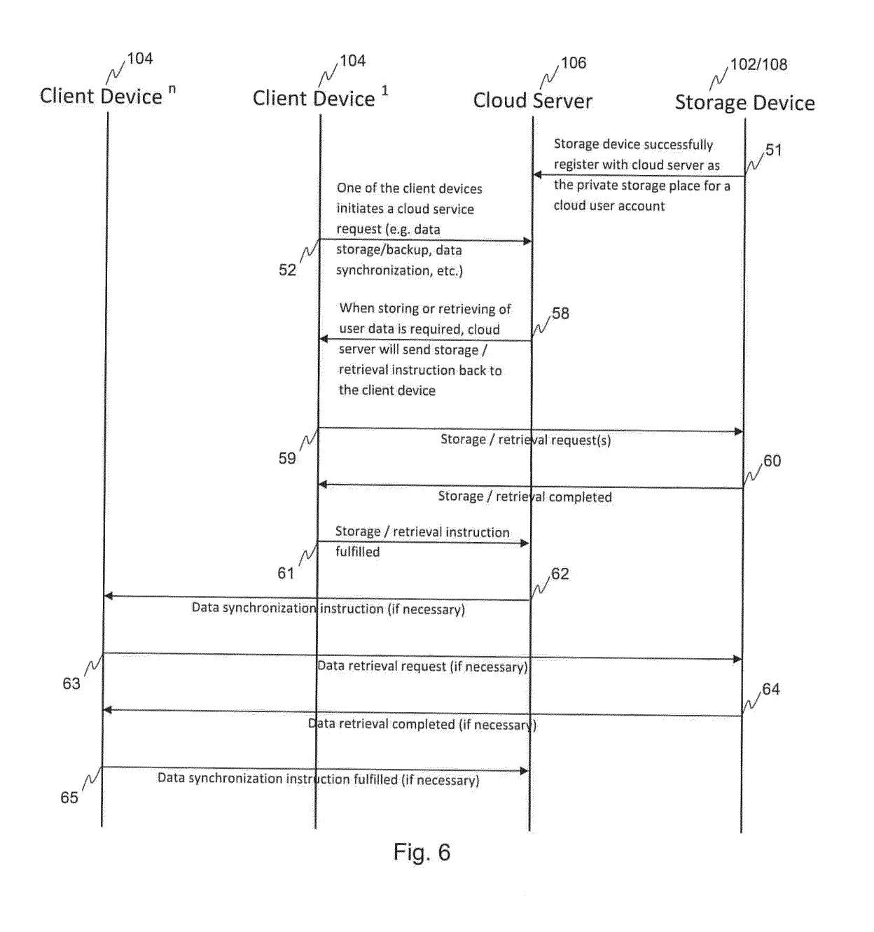

FIG. 6 is a sequence chart depicting a typical event relationship among client devices 104, cloud server 106, and storage device 102/108 according to another embodiment as shown in FIG. 3 when client devices 104 can be directly connected to storage device 102/108. Methods for determining if direct connection is possible are well known at the time of this application. In this embodiment if direct connection can be established between client devices 104 and storage device 102/108, cloud server 106 will not send storage/retrieval request(s) to storage device 102/108 but instead sending instruction(s) to client devices 104 for client devices 104 to send the actual storage/retrieval request(s) to storage device 102/108 directly. The beginning process is the same as in FIG. 5 that storage device 102/108 must be successfully authenticated as the private storage for a particular user account of the cloud service (51). Methods of providing authentication information are well-known at the time of this application. Thereafter storage device 102/108 will be used by cloud server 106 when storage/retrieval of user data 26 is required for a certain user account of the cloud service. At any moment when one of the client devices 104 requires a cloud service (e.g. data storage/backup, new data becoming available, etc.) the initiated client device 104 (Client Device¹) will send cloud service request(s) to cloud server 106 (52). When processing the cloud service, storage/retrieval instruction(s) will be sent to the initiated client device 104 (Client Device¹) from cloud server 106 if storage/retrieval of user data 26 is required (58). This is to instruct the initiated client device 104 (Client Device¹) to send the actual storage/retrieval request(s) to storage device 102/108 (59). If necessary storage device 102/108 will then send storage/retrieval confirmation(s) back to the initiated device 104 (Client Device¹) when the storage/retrieval request(s) have been completed (60) and followed by cloud service completion confirmation(s) back to cloud server 106 from the initiated client device 104 (Client Device¹) when the storage/retrieval instruction(s) have been fulfilled (61).

If data synchronization is required, synchronization instruction(s) will be sent from cloud server 106 (62) to all other client devices 104 (Client Devices″) designated by the user to share/synchronize user data 26 received from the initiated device 104 (Client Device¹). This is different from synchronization request(s) (56) as shown in FIG. 5 because cloud server 106 does not send synchronization data to Client Devices″. Instead it is instructing Client Devices″ to directly communicate with storage device 102/108 to retrieval such synchronization data. After receiving data synchronization instruction(s) from cloud server 106 at Client Device″, retrieval request(s) will be sent from Client Devices″ a to storage device 102/108 to retrieve synchronization data (63). This is followed by data retrieval confirmation(s) sent from storage device 102/108 to Client Device″ when retrieval request(s) have completed (64) and finished with confirmation(s) back to cloud server 106 from Client Devices″ when data synchronization instruction(s) have been fulfilled (65).

This embodiment as described in FIG. 6 allows significant saving of data bandwidth usage at cloud server 106. Hence operation costs can be greatly reduced. Optionally exception handling can be implemented to deal with failure situations for each event in all the embodiments.

While embodiments of the method of the application are described in the order of steps as shown, a reasonable person of ordinary skill in the art would understand that the order is not so limited. For example, in some embodiments, the storage/retrieval request (54) as well as other type of requests can be more than 1 or repeated for operational requirement and fulfillment purposes. For another example, many of the confirmation such as 61 are optional.

It will be readily understood that, through use of the foregoing described method, general privacy concern in storage potentially sensitive personal data in the hands of a third party (the servers of the cloud service provider) can be overcome because storage of user data is now in a private storage designated and owned/possessed by the user of the cloud service. In addition, “Cyber foot print” can also be guaranteed when the user stops using this cloud service or configures a new local storage as the old storage will immediately be “vanished” from the Internet without a trace when it is erased, formatted, or physically removed by the user. In addition, because the storage device is manageable by the cloud server, cloud server can optionally apply limitations at the storage device such as limiting the storage space, file type, file size, etc. Finally this solution can also be implemented in a cost effective manner because hard drive storage is provided by the user of the cloud service instead of the cloud service provider.

The many features and advantages of the application are apparent from the detailed specification, and thus, it is intended by the appended claims to cover all such features and advantages of the application which fall within the true spirit and scope of the application. Further, since numerous modifications and variations will readily occur to those skilled in the art, it is not desired to limit the application to the exact construction and operation illustrated and described, and accordingly, all suitable modifications and equivalents may be resorted to, falling within the scope of the application.

What is claimed is:

1. A method of providing private storage in a cloud service on a network comprising the steps of:
(a) receiving at a second computer a communication from a first computer that includes data for locating the first computer on the network;
(b) receiving at a second computer a communication from a third computer a request for cloud service;
(c) sending from a second computer to a first computer a request for data storage/retrieval when performing the cloud service requested by a third computer;

2. The method of claim 1 wherein the first computer is owned and designated by the user of an account at cloud server.

3. The method of claim 1 wherein the network address of first computer can be accessed publicly from the network.

4. The method of claim 1 wherein the network address of first computer cannot be accessed publicly from the network such as behind a firewall or connected indirectly via a gateway, router, network address translator, etc.

5. The method of claim 1 wherein authentication is required for first computer to register with second computer before second computer permitting first computer to be used as the private storage for one or more user accounts.

6. The method of claim 5 wherein the step of receiving authentication information includes the step of receiving data encrypted with a public encryption key assigned to a user of the first computer.

7. The method of claim 1 wherein communication from first computer to second computer is repeated from time to time.

8. The method of claim 1 further comprising the step of the second computer limiting the amount of storage space in first computer to be allowed for one or more user accounts.

9. A system comprising:
a) a storage device linked to a network and associated with a network address, the storage device being configured to send a signal that includes data for locating the storage device within the network;
b) a cloud server computer linked to the network and associated with another network address, the cloud server computer being configured to receive from the storage device a signal that includes data corresponding to the data for locating the storage device;
c) a client device linked to the network and capable of sending requests for cloud services to the cloud server computer;
wherein the client device is configured to generate a request for cloud service based on a defined event occurring at the client device;
wherein the cloud service computer is configured in response at least in part to the request for cloud service to generate a request to the storage device for data storage/retrieval when performing the cloud service requested by the client device.

10. A system comprising:
a) a storage device linked to a network and associated with a network address, the storage device being configured to send a signal that includes data for locating the storage device within the network;
b) a cloud server computer linked to the network and associated with another network address, the cloud server computer being configured to receive from the storage device a signal that includes data corresponding to the data for locating the storage device;
c) a client device linked to the network for sending requests for cloud services to the cloud server computer;
wherein the client device is configured to generate a request for cloud service based on a defined event occurring at the client device;
wherein the cloud server computer is operable to determine if the client device can be directly connected to storage device;
wherein the cloud server computer is further configured in response at least in part to the request for cloud service to either generate a data storage/retrieval request to the storage device when performing the cloud service requested by the client device if the client device cannot be connected directly with the storage device, or generate a data storage/retrieval instruction to the client device instructing the client device to send an actual data storage/retrieval requests to the storage device if the client device can be connected directly with the storage device.

11. The system of claim 10 wherein the storage device is owned and designated by the user of an account of cloud server.

12. The system of claim 10 wherein the network address of storage device can be accessed publicly from the network.

13. The system of claim 10 wherein the network address of storage device cannot be accessed publicly from the network such as behind a firewall or connected indirectly via a gateway, router, network address translator, or the like.

14. The system of claim 10 wherein authentication is required for storage device to register with cloud server computer before cloud server computer permitting storage device to be used as the private storage for one or more user accounts.

15. The system of claim 10 wherein the authentication information includes receiving data encrypted with a public encryption key assigned to a user of the storage device.

16. The system of claim 10 wherein communication from storage device to cloud server computer is repeated from time to time.

17. The system of claim 10 further comprising the cloud server computer limiting the amount of storage space in storage device to be allowed for one or more user accounts.

18. A computer software product for use on a cloud server computer linked to a network for providing cloud services to a client device with user data storage/retrieval on a storage device designated/owned by the users of the cloud service, the computer program product comprising:
a) a computer usable medium;
b) computer readable program codes recorded or storable in the computer useable medium, the computer readable program codes defining a cloud server computer software on the cloud server computer wherein:
i. the cloud server computer software is operable to enable a connection between the cloud server computer and the storage device in response to a communication sending from the storage device to the cloud server computer; and
ii. the cloud service computer software is operable to respond at least in part to the request for cloud service receiving from a client device to generate a request to the storage device for data storage/data retrieval when performing cloud services requested by a client device.

19. A computer software product for use on a cloud server computer linked to a network for providing cloud services to a client device with user data storage/retrieval on a storage device designated/owned by the users of the cloud service, the computer program product comprising:
a) a computer usable medium;
b) computer readable program codes recorded or storable in the computer useable medium, the computer readable program codes defining a cloud server computer software on the cloud server computer wherein:
i. the cloud server computer software is operable to enable a connection between the cloud server computer and the storage device in response to a communication sending from the storage device to the cloud server computer; and
ii. the cloud server computer software is operable to determine if a client device can be directly connected to the storage device; wherein the cloud server computer software is further operable to respond at least in part to the request for cloud service receiving from a client device to either generate a data storage/retrieval request to the storage device when performing cloud services if the client device cannot be connected directly with the storage device, or generate a data storage/retrieval instruction to a client device instructing the client device to send an actual data storage/retrieval requests to the storage device if the client device can be connected directly with the storage device.

20. The computer software product in claim 19 wherein the communication sent from the storage device to the cloud server computer includes data for locating the storage device on the network;
